(19) United States
(12) Patent Application Publication
(10) Pub. No.: US 2015/0208109 A1
(43) Pub. Date: Jul. 23, 2015

(54) SYSTEMS, METHODS AND APPARATUS FOR PROVIDING MULTIMEDIA CONTENT TO HAIR AND BEAUTY CLIENTS

(71) Applicant: Alexandre CHTCHENTININE, Vaughan (CA)

(72) Inventor: Alexandre Chtchetinine, Vaughan (CA)

(21) Appl. No.: 14/413,253

(22) PCT Filed: Jul. 4, 2013
(86) PCT No.: PCT/CA2013/000618

§ 371 Date: Jan. 7, 2015

Related U.S. Application Data
(60) Provisional application No. 61/670,848, filed on Jul. 12, 2012.

(51) Int. Cl. H04N 21/2668; H04N 21/214; H04N 21/81; H04N 21/442

(52) U.S. Cl. CPC H04N 21/2668; H04N 21/44218; H04N 21/2143; H04N 21/812

(57) ABSTRACT

Systems, methods and apparatus for providing multimedia content to a hair and beauty client. The method comprises receiving a primary set of multimedia content; displaying a secondary set of multimedia content in a field of view, wherein the secondary set of multimedia content corresponds to the primary set of multimedia content; detecting client engagement with the secondary set of multimedia content; determining whether to update the secondary set of multimedia content in accordance with the client engagement; and if update is required, updating the secondary set of multimedia content.

### FIELD

The described embodiments relate to the delivery of multimedia content and, in particular, delivery of multimedia content to a captive audience.

### BACKGROUND

In a salon or a spa, a client receiving a treatment or a service is limited in his/her head or body movement. Client's location and range of vision is typically fixed, thereby making him/her a captive audience. For example, while receiving a haircut, the client location may be limited to a salon chair and client range of vision may be limited to a mirror mounted in front of the chair.

Furthermore, a process or a treatment at a salon typically has a long duration. For example, a hair treatment involving washing, cutting and styling, can take anywhere from 30 to 90 minutes. Accordingly, the attention of the client is fixed in one general direction for a long duration. This presents an opportunity for content providers, such as advertisers, to deliver multimedia content to such a captive audience.

### SUMMARY

In one aspect, in at least one embodiment described herein, there is provided a method for providing multimedia content to a client in a salon. The method comprises receiving a primary set of multimedia content, displaying a secondary set of multimedia content in a field of view, wherein the secondary set of multimedia content corresponds to the primary set of multimedia content, detecting client engagement with the secondary set of multimedia content, determining whether to update the secondary set of multimedia content in accordance with the client engagement, and updating the secondary set of multimedia content if update is required.

In some examples, the secondary set of multimedia content may be the same as the primary set of multimedia content. In some other examples, the secondary set of multimedia content may comprise the primary set of multimedia content and alternate content.

The secondary set of multimedia content may alternatively comprise a subset of the primary set of multimedia content. In some further examples, the secondary set of multimedia content comprises a subset of the primary set of multimedia content in combination with alternate content.

The secondary set of multimedia content may also comprise a processed version of some or all of the primary set of multimedia content. The secondary set of multimedia content may alternatively comprise a processed version of some or all of the primary set of multimedia content in combination with alternate content.

The method may comprise updating the secondary set of multimedia content by analyzing the client engagement to determine an engagement level, generating a request for updated multimedia content based on the engagement level and receiving the primary set of multimedia content based on the request for updated multimedia content. In some other examples, the secondary set of multimedia content may be updated based on client actions or interactions, such as, for example, client voice commands, client physical touch and client gestures etc.

In some embodiments, the method comprises detecting a presence of the client, wherein displaying the secondary set of multimedia content is based on the presence of the client. In some other embodiments, the presence of the client is detected based on client actions.

In some embodiments, the method comprises determining a client characteristic and receiving the primary set of multimedia content based on the client characteristic. Client characteristic may comprise client age, gender etc. In some other embodiments, the primary set of multimedia content may be received or customized based on client actions.

In some examples, displaying the secondary set of multimedia content comprises displaying an interactive content to the client. Interactive content may include barcodes, QR codes and other content allowing the client to interact with the multimedia content.

In another aspect, in at least one embodiment described herein, there is provided a system for providing multimedia content to a client in a salon. The system comprises a multimedia content server configured to store multimedia content; and an apparatus operably connected to the multimedia content server over a network. The apparatus comprises a network interface configured to receive a primary set of multimedia content from the multimedia content server; a display module configured to display a secondary set of multimedia content in a field of view, the secondary set of multimedia content corresponding to the primary set of multimedia content; an engagement detection module configured to detect client engagement with the secondary set of multimedia content; a processor configured to determine whether to update the secondary set of multimedia content; and an updating module configured to update the secondary set of multimedia content.

The system may comprise a presence detection module configured to detect a presence of the client. The system may also comprise a customization module configured to determine client characteristics.

The system may further comprise a mounting surface such that the apparatus is detachably attached to a mounting surface. The system may also comprise at least one of a sensor and a camera.

In another aspect, in at least one embodiment described herein, there is provided an apparatus for providing multimedia content to a client in a salon. The apparatus comprises a network interface configured to receive a primary set of multimedia content from a multimedia content server; a display module configured to display a secondary set of multimedia content in a field of view, the secondary set of multimedia content corresponding to the primary set of multimedia content; an engagement detection module configured to detect client engagement with the secondary set of multimedia content; a processor configured to determine whether to update the secondary set of multimedia content; and an updating module configured to update the secondary set of multimedia content.

### BRIEF DESCRIPTION OF THE DRAWINGS

Preferred embodiments of the present invention will now be described in detail with reference to the drawings, in which:

FIG. 1 illustrates a block diagram of a multimedia content delivery system in accordance with an example embodiment;

FIG. 2 illustrates a block diagram of a multimedia content delivery system in accordance with another example embodiment;

FIG. 3 illustrates a block diagram of a display apparatus in accordance with an example embodiment;

FIG. 4 illustrates a block diagram of a multimedia content server in accordance with an example embodiment; and

FIG. 5 illustrates a process flow followed by a multimedia content delivery system in accordance with an example embodiment.

The drawings, described below, are provided for purposes of illustration, and not of limitation, of the aspects and features of various examples of embodiments described herein. The drawings are not intended to limit the scope of the teachings in any way. For simplicity and clarity of illustration, elements shown in the figures have not necessarily been drawn to scale. The dimensions of some of the elements may be exaggerated relative to other elements for clarity. Further, where considered appropriate, reference numerals may be repeated among the figures to indicate corresponding or analogous elements.

### DESCRIPTION OF EXEMPLARY EMBODIMENTS

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing implementation of the various embodiments described herein.

The embodiments of the systems, methods and apparatus described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example, and without limitation, the various programmable computers may be a server, network appliance, set-top box, embedded device, computer expansion module, personal computer, laptop, personal data assistant, cellular telephone, smartphone device, UMPC tablets and wireless hypermedia device or any other computing device capable of being configured to carry out the methods described herein.

Program code is applied to input data to perform the functions described herein and to generate output information. The output information is applied to one or more output devices, in known fashion. In some embodiments, the communication interface may be a network communication interface. In embodiments in which elements of the invention are combined, the communication interface may be a software communication interface, such as those for inter-process communication (IPC). In still other embodiments, there may be a combination of communication interfaces implemented as hardware, software, and combination thereof.

Each program may be implemented in a high level procedural or object oriented programming or scripting language, or both, to communicate with a computer system. However, alternatively the programs may be implemented in assembly or machine language, if desired. The language may be a compiled or interpreted language. Each such computer program may be stored on a storage media or a device (e.g. ROM, magnetic disk, optical disc), readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the systems, methods and apparatus of the described embodiments are capable of being distributed in a computer program product including a physical, non-transitory computer readable medium that bears computer usable instructions for one or more processors. The medium may be provided in various forms, including one or more diskettes, compact disks, tapes, chips, magnetic and electronic storage media, and the like. The computer useable instructions may also be in various forms, including compiled and non-compiled code.

The described embodiments may generally provide systems, methods and apparatus to provide multimedia content to a client in a spa or a salon. Client refers to salon customers receiving professional services or treatments in the salon. Client may also refer to other personnel in the spa or salon, such as, for example, salon operators.

Salon operators may include individuals providing professional salon or spa services, such as, hairstylists, make-up artists etc. Salon operators may also include other individuals at the salon, such as, salon owners, managers or employees etc.

A salon or spa generally refers to an establishment that offers professional beautification or relaxation services, such as, for example, hair services, cosmetic services, massage services etc.

The various methods, systems and apparatus as described herein may also provide multimedia content to customers, operators and other personnel in other captive establishments, such as, for example, retail points of sale, or a healthcare establishment comprising a doctor's office, a dentist's office etc.

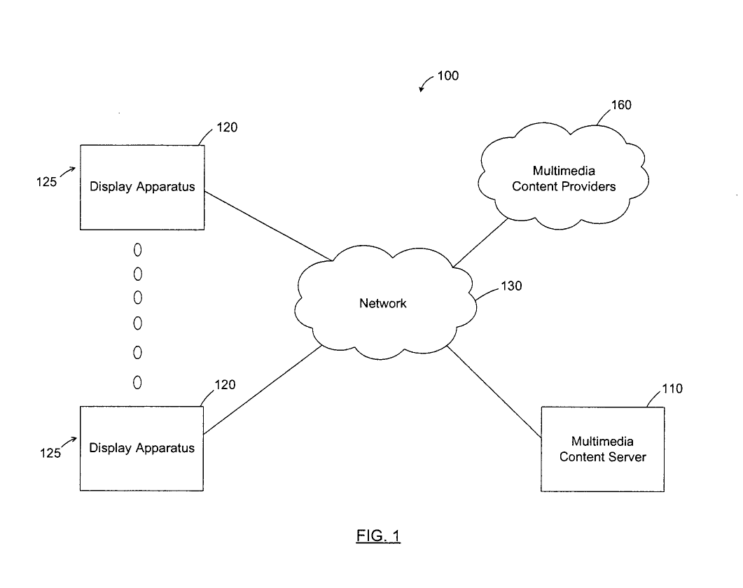

Reference is first made to FIG. 1, illustrating a block diagram of components comprising a multimedia content delivery system 100 in accordance with an example embodiment. System 100 generally comprises a multimedia content server 110, a display apparatus 120 and a network 130. System 100 can include a plurality of display apparatuses 120. Each display apparatus 120 is configured to display multimedia content to at least one client 125. System 100 may also comprise one or more multimedia content providers 160.

The multimedia content server 110 may comprise one or more servers equipped with a processor and a computer readable storage module. The multimedia content server 110 may be any server that can provide access to multimedia content, such as video content, audio content, animations, images, text or a combination of these etc. For example, the multimedia content server 110 provides access to advertisements, movie clips, TV show clips, music videos, video blogs etc.

In some examples, the multimedia content server 110 stores a wide variety of multimedia content locally. In some other examples, the multimedia content server 110 is coupled to one or more multimedia content providers 160, e.g. via network 130, to receive multimedia content. In some further examples, the multimedia content server 110 comprises the multimedia content provider 160.

Multimedia content providers 160 may comprise one or more multimedia content developers and/or distributors. For example, multimedia content providers 160 may include advertising content developers and/or providers, entertainment content developers and/or providers etc. In some examples, the multimedia content server 110 requests multimedia content from the multimedia content providers 160. In some other examples, the multimedia content server 110 is configured to receive multimedia content from the multimedia content provider 160 at regular intervals. The multimedia content may alternatively be received by the multimedia content server 110 as a combination of these.

The multimedia content server 110 may or may not store the multimedia content received from the multimedia content provider 160 locally. In some examples, the multimedia content server 110 transmits the multimedia content received from the multimedia content provider 160 to one or more display apparatuses 120 as soon as the content is received. For example, the multimedia content server 110 may request multimedia content from the multimedia content provider 160 and when received, transmit the content to the display apparatus 120 without storing the content locally. In some other examples, the multimedia content server 110 stores the multimedia content received from the multimedia content provider 160 locally. The multimedia content server 110 may be configured to process or manipulate the multimedia content, as discussed below.

The multimedia content server 110 interfaces with one or more display apparatuses 120 via network 130. In some examples, the multimedia content server 110 is independently coupled to each display apparatus 120 in the system 100. In such examples, different multimedia content is transmitted to different display apparatuses 120 in system 100. In some other examples, the multimedia content server 110 is collectively coupled with more than one display apparatuses 120 in the system 100. In such examples, same multimedia content is transmitted to more than one display apparatuses 120 coupled to the multimedia content server 110.

System 100 can include any number of multimedia content servers 110 and multimedia content providers 160, although only one of each is shown in this example. Multiple multimedia content servers 110 may be distributed over a wide geographical area and connected via e.g. network 130. Similarly, multiple multimedia content providers 160 may be distributed over a wide geographical area and connected via e.g. network 130.

Network 130 may be any network(s) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

The display apparatus 120 is any device comprising a display module, and configured to receive a primary set of multimedia content via network 130. The primary set of multimedia content may comprise video and/or audio clips, such as movie clips, advertisements, music videos, images, animations, text, computer software or programs, or a combination of these etc. Display apparatus 120 may be a liquid-crystal display (LCD) screen, a light-emitting diode (LED) screen, an organic light-emitting diode (OLED) screen, a field emission display (FED), a surface-conduction electron-emitter display (SED), a plasma screen, a monitor, a cathode ray tube (CRT) screen, a digital photo frame (DPF) etc.

In some embodiments, the display apparatus 120 is any networked computing device further comprising a processor and memory, such as a personal computer, workstation, server, portable computer, mobile device, personal digital assistant, laptop, smart phone, WAP phone, an interactive television, video display terminals, gaming consoles, an electronic reading device, and portable electronic devices or a combination of these.

In some embodiments, the display apparatus 120 is configured to receive the primary set of multimedia content from the multimedia content server 110. The content may be received at predetermined intervals and/or in response to a request by the display apparatus 120. In some examples, each display apparatus 120 in system 100 has a unique IP address associated with it, and accordingly, each display apparatus 120 is configured to independently receive multimedia content. In some other examples, more than one display apparatus 120 is configured to receive the same multimedia content.

In some other embodiments, the display apparatus 120 is configured to receive the primary set of multimedia content directly from the multimedia content provider 160, e.g. via network 130. The multimedia content may be received by the display apparatus 120 from the multimedia content provider 160 based on a request from the display apparatus 120. The multimedia content may alternatively or collectively be received by the display apparatus 120 at regular intervals from the multimedia content provider 160.

In system 100, each display apparatus 120 is configured to display a secondary set of multimedia content to at least one client 125. A client 125 may be a customer, an owner, an operator, and/or any other personnel in captive establishments, for example, a salon/spa, a dentist's office etc. A secondary set of multimedia content is defined as the multimedia content displayed to a client by the display apparatus 120. In some examples, the secondary set of multimedia content is the same as the primary set of multimedia content. In some other examples, the secondary set of multimedia content comprises a subset of the primary set of multimedia content.

The secondary set of multimedia content may also comprise some or all of the primary set of multimedia content in combination with some alternate content. In some further examples, the secondary set of multimedia content comprises a processed version of some or all of the primary set of multimedia content and/or processed versions of some or all of the primary set of multimedia content with alternate content. Alternate content may be any content stored locally in the display apparatus 120.

In one example, the secondary set of multimedia content displayed to the client can be client's own image with superimposed elements such as, for example, different hairstyles or hair colors. In a further embodiment, the secondary set of multimedia content displayed to the client can be client's own image superimposed over backdrop elements such as, for example, images from travel destinations. In some embodiments, the display apparatus 120 may be configured to take a snap shot of the client and store it locally. The primary set of multimedia content received from the multimedia content server may comprise a software program for combining the client image with superimposed and/or backdrop elements. Accordingly, the secondary set of multimedia content displayed to the client comprises combining and displaying the locally stored client image with superimposed and/or backdrop elements.

In some other embodiments, the display apparatus 120 may take a snap shot of the client and transmit it to the multimedia content server. The combining of the client image with superimposed and/or backdrop elements may take place at the multimedia content server. Accordingly, the primary set of multimedia content may comprise pictorial representation of the client with superimposed and/or backdrop elements. In such embodiments, the secondary set of multimedia content displayed to the client may be the same as the primary set of multimedia content.

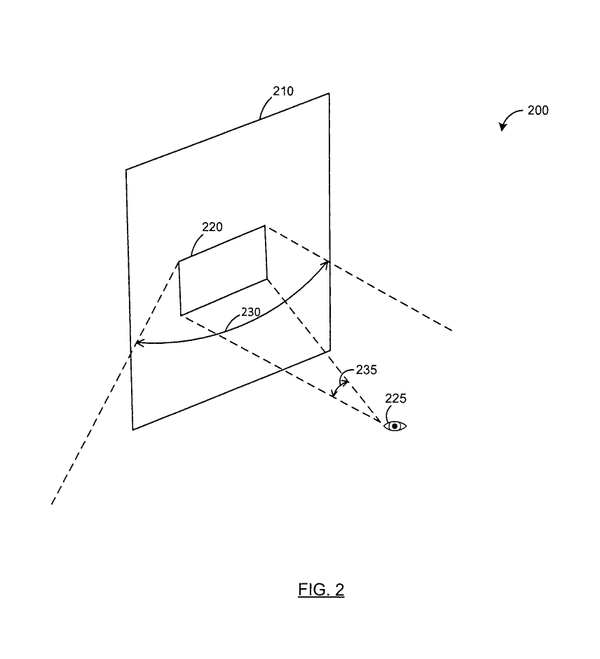

Reference is next made to FIG. 2 illustrating a block diagram of a multimedia content delivery system 200 in a salon in accordance with an example embodiment. System 200 comprises a mounting surface 210, a display apparatus 220 and a client 225. As illustrated, display apparatus 220 displays the secondary set of multimedia content to client 225. Each client 225 has an associated range of vision 235 that identifies the spatial volume where the client's focus may be typically fixed during a service or a treatment at the salon.

The mounting surface 210 is any surface that mounts or holds the display apparatus 220 in place. The mounting surface 210 may mount the display apparatus 220 by, for example, attaching some or all of the display apparatus 220 to itself. The mounting surface 210 may alternatively mount the display apparatus 220 by, for example, suspending the display apparatus 220 via a protruded surface (e.g. a wedge or a screw etc.) The mounting surface 210 may be a mirror. Alternatively, the mounting surface 210 may be a wall.

The display apparatus 220 may be similar to the display apparatus 120. In some examples, the display apparatus 220 is a wired device. For example, the display apparatus 220 may be connected to a router within the salon or other captive establishment via cables or wires for connection to a network, such as network 130. In some other examples, the display apparatus 220 is wirelessly connected to a router within the captive establishment.

The display apparatus 220 may be configured to detachably attach to the mounting surface 210. For example, the display apparatus 220 may be attached to the mounting surface 210 using a Velcro attachment. As another example, the display apparatus 220 may be suspended on a wedge or a screw attached to the mounting surface 210.

The display apparatus 220 further comprises an associated field of view 230. The field of view 230 spans a spatial volume that receives the secondary set of multimedia content from the display apparatus 230. The field of view 230 may be defined in terms of angles. For example, a field of view 230 may be defined as having a horizontal range of 180° and a vertical range of 100°.

The field of view 230 may additionally be defined in terms of a horizontal distance from the display apparatus 220. For example, the field of view 230 may be defined in terms of angles and distance, such as having a horizontal range of 180°, a vertical range of 100° and a distance of 1.5 meters referring to the spatial volume receiving the secondary set of multimedia content.

The display apparatus 220 may be further configured to adjust its orientation angle by, for example, moving up or down in a vertical direction, or moving left or right in a horizontal direction, while mounted at a fixed location. In some examples, the display apparatus 220 automatically adjusts the orientation angle based on the client location, such as, for example, client distance from the display apparatus 220. The display apparatus 220 may also automatically adjust the orientation angle based on client characteristic, such as, for example, client height.

In some examples, the display apparatus 220 may automatically adjust the orientation angle, and accordingly, the field of view 230 based on the client range of vision 235. In some other examples, the display apparatus 220 may also adjust the orientation angle based on client action. Client action or interaction may comprise client physical touch (for example, pressing an icon, a button etc.), client gestures (for example, thumbs up, thumbs down etc.), client voice commands etc.

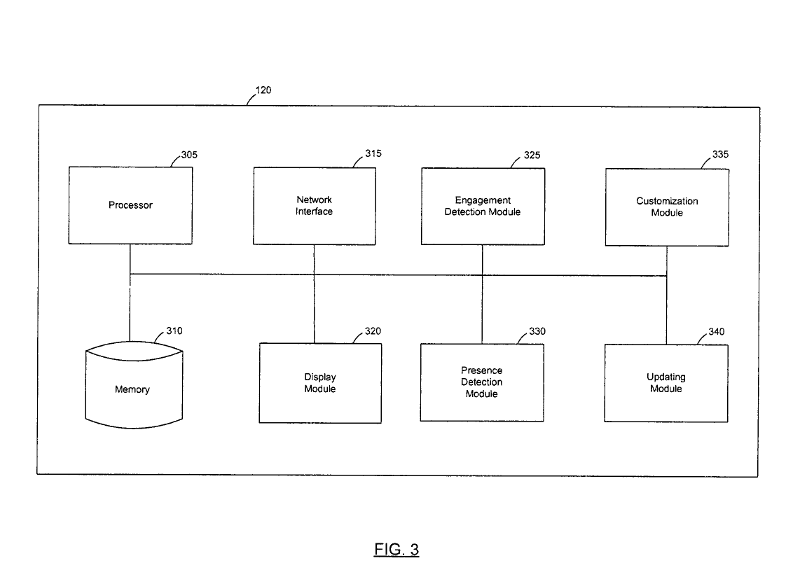

Reference is now made to FIG. 3 illustrating a simplified block diagram of an exemplary display apparatus, such as display apparatus 120 or 220. The display apparatus of FIG. 3 is referred to as display apparatus 120 for convenience only. The teachings of FIG. 3 are equally applicable to display apparatus 220.

The display apparatus 120 may comprise a processor 305, a memory 310, one or more network interface 315, a display module 320, an engagement detection module 325, a presence detection module 330, a customization module 335 and an updating module 340.

The display apparatus 120 comprises a network interface 315 for connecting to network, such as network 130, to communicate with other components in the system 100, such as the multimedia content server 110. Network interface 315 may be configured to receive a primary set of multimedia content from a multimedia content server, such as the multimedia content server 110. The primary set of multimedia content may also be received from a multimedia content provider, such as the multimedia content provider 160.

Display module 320 is configured to display a secondary set of multimedia content to a client, such as client 125 or 225. In some examples, the secondary set of multimedia content is the same as the primary set of multimedia content. In some other examples, the processor 305 processes or modifies the primary set of multimedia content before displaying it to the client. For example, the processor 305 may extract a subset of the primary set of multimedia content for display to the client.

The processor 305 may combine a subset of the primary set of multimedia content with alternate content. Alternate content comprises some or all of multimedia content stored locally in the memory 310 of the display apparatus 120. The processor 305 may alternatively combine the entire primary set of multimedia content as received from the multimedia content server with alternate content stored locally in the memory 310.

In some further examples, the secondary set of the multimedia content displayed to the client includes only the alternate content stored in the memory 310 of the display apparatus 120.

Engagement detection module 325 may be configured to detect or estimate a level of client engagement with the secondary set of multimedia content displayed to the client. In some embodiments, the engagement detection module 325 may be configured to determine a level of client engagement based on a scale from ‘1’ to ‘10’, where ‘1’ may indicate the least level of satisfaction and ‘10’ may indicate the highest level of satisfaction.

In some other embodiments, the engagement detection module 325 may be configured to determine the level of client engagement as ‘satisfied’ or ‘unsatisfied’.

Alternatively, the engagement detection module 325 may be configured differently to determine or estimate a level of client satisfaction with the secondary set of multimedia content.

The engagement detection module 325 may be configured to gauge the level of client satisfaction in a variety of different ways. In some examples, the display apparatus 120 comprises a camera that captures the client expression or reaction to the secondary set of multimedia content. In one embodiment, the camera may be a video camera. In a different embodiment, the camera may be a digital photo camera configured to capture the client expression or reaction at, for example, selected intervals. In some other examples, the display apparatus 120 comprises sensors, such as eyeball or retina detection sensors, to gauge the level of client satisfaction.

In some further examples, the client, for example, the customer or other salon personnel, directly provides an indication of engagement or satisfaction with the secondary set of multimedia content. Indication of engagement may be provided, for example, by pressing a number from ‘1’ to ‘10’ on the display apparatus 120, where the number pressed indicates the level of client satisfaction. Alternatively, indication of engagement may be provided by the client verbally. Indication of engagement may also be provided by using any other gesture, such as, ‘thumbs up’ or ‘thumbs down’ gesture etc.

Presence detection module 330 may be configured to detect client presence near the display apparatus 120. The display apparatus 120 may be configured to turn ‘on’ or ‘off’ based on the client presence near the display apparatus 120. The presence detection module 330 may be configured to detect client presence based on one or more predefined parameters. For example, the presence detection module 330 may detect client's presence near the display apparatus 120 if the client is detected in a field of view, such as the field of view 230, of the display apparatus 120 for at least a fixed duration of time. For example, the presence detection module 330 may be configured to turn on the display apparatus 120 if the client presence is detected for at least a period of 5 minutes within the field of view of the display apparatus 120.

In some examples, the display apparatus 120 comprises a camera for detecting the presence of the client in the field of view. In one embodiment, the camera may be a video camera. In a different embodiment, the camera may be a digital photo camera configured to detect the presence of the client in the field of view at, for example, selected intervals. In some other examples, the display apparatus 120 comprises one or more sensors, such as motion detection sensors, thermal sensors etc., to detect the presence of the client in the field of view. The presence of the client may also be indicated by a client action, such as, for example, by manually switching on the display apparatus 120.

In some examples, a seating surface in a captive establishment, such as, for example, a chair in a salon or a dentist office, may comprise one or more sensors, such as, for example, a pressure sensor or a thermal sensor etc. to detect the presence of the client in the field of view.

Customization module 335 may be configured to customize the secondary set of multimedia content displayed to the client. The customization of secondary set of multimedia content may be done in a variety of ways.

In some examples, the customization module 335 may be configured to display the secondary set of multimedia content based on client characteristics. For example, the customization module 335 may be configured to estimate the client age and customize the secondary set of multimedia content based on the client age. As another example, the customization module 335 may be configured to estimate the client gender and customize the secondary set of multimedia content based on the client gender. For example, the customization module 335 may determine the client to be a female, and accordingly the secondary set of multimedia content may comprise female-specific multimedia content, such as advertisements for female clothing, make-up or hair products etc.

In some other examples, the customization module 335 may be configured to customize the secondary set of multimedia content based on client interactions. For example, the secondary set of multimedia content may be customized based on client voice commands. The secondary set of multimedia content may also be customized based on client gestures.

In some embodiments, the customization module 335 may be configured to customize the secondary set of multimedia content by transmitting the detected client characteristics or received client interactions to a multimedia content server, such as the multimedia content server 110. The multimedia content server transmits a primary set of multimedia content to the display apparatus 120 based on the client characteristics and/or client interactions.

In some other embodiments, the processor 305 processes or analyzes the client characteristics and/or client interactions detected by the customization module 335 and determines the suitable primary set of multimedia content to be received from the multimedia content server. The customization module 335 then initiates a request for the primary set of multimedia content from the multimedia content server.

The updating module 340 may be configured to determine whether to update the secondary set of multimedia content based on the level of engagement detected by the engagement detection module 325.

In one embodiment, the updating module 340 transmits the detected engagement level to the multimedia content server, such as the multimedia content server 110. The multimedia content server then processes the client engagement and determines whether to update the multimedia content or not. In some other embodiments, the updating module 340 processes the detected client engagement and determines whether to update the secondary set of multimedia content or not.

The updating module 335 may be further configured to update the secondary set of multimedia content. In some embodiments, the updating module 335 may update the secondary set of multimedia content by processing the engagement level and determining a suitable primary set of multimedia content to be received from the multimedia content server. The updating module 335 then initiates a request for the primary set of multimedia content from the multimedia content server. In some other embodiments, the multimedia content server determines the suitable primary set of multimedia content based on the client engagement and transmits it to the display apparatus 120.

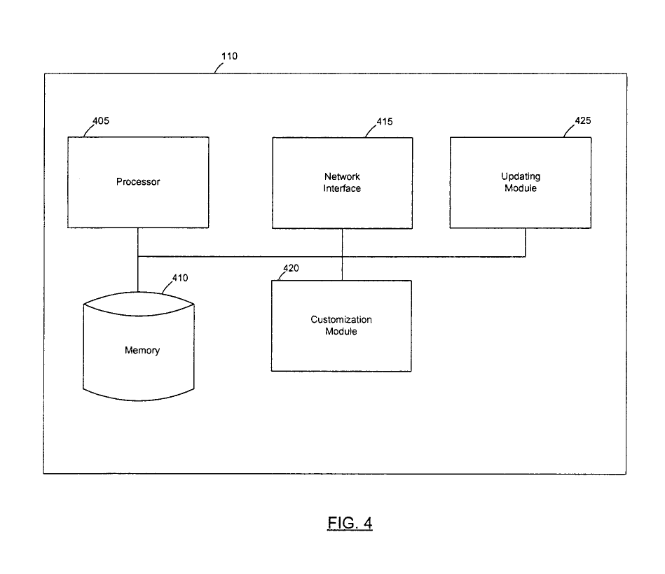

Referring now to FIG. 4, a simplified block diagram of an exemplary multimedia content server, such as the multimedia content server 110. Multimedia content server 110 may comprise a processor 405, a memory 410, one or more network interface 415, a customization module 420 and an updating module 425.

One or more network interface 415 may be configured to connect the multimedia content server 110 to the network, such as network 130. The multimedia content server 110 may communicate with other components in the system 100 or 200, such as the display apparatus 120 or 220, one or more multimedia content providers 160 etc.

The customization module 420 may be configured to receive a customization request from a display apparatus, such as the display apparatus 120 or 220. The customization request may comprise one or more criteria based on which the multimedia content is customized. For example, the customization module 420 may receive client characteristic, such as, for example, client age or gender etc. in the customization request. The customization module 420 may also receive client interaction, such as, for example, client gestures, client voice commands etc. in the customization request.

The customization module 420 may comprise tables, such as look-up-tables (LUTs) to determine multimedia content corresponding to a plurality of variables. The plurality of variables can correspond to client interactions and/or client characteristics such as, for example, age and gender. In a further embodiment, the plurality of variables can correspond to, for example, the location of the salon, events surrounding the location of the salon and/or prevalence of specific demographics of the population surrounding the location of the salon, such as, for example, gender, age, income, ethnicity and/or language. In still a further embodiment, the plurality of variables can correspond to temporal considerations such as, for example, the time of day, the day of the week and/or the season of the year. In yet a further embodiment, the plurality of variables can correspond to advertising goals such as, for example, revenue optimization, targeted demographics and/or quotas corresponding to a number of impressions to be reached. The LUTs may be generated specifically for use with a single display apparatus 120 or 220, or for use with a plurality of display apparatuses 120 or 220.

The updating module 425 may be configured to receive an updating request from a display apparatus, such as the display apparatus 120 or 220. The updating request may comprise the client engagement level with the secondary set of multimedia content being displayed. For example, the updating module 425 may receive a client engagement level on a scale of ‘1’ to ‘10’, such as, for example, level ‘5’ in the updating request. The customization module 420 may alternatively receive a satisfied or an unsatisfied status in the updating request.

The updating module 425 may comprise tables, such as look-up-tables (LUTs) to determine multimedia content corresponding to client engagement level in the updating request. The LUTs may be generated specifically for use with a single display apparatus 120 or 220, or for use with a plurality of display apparatuses 120 or 220.

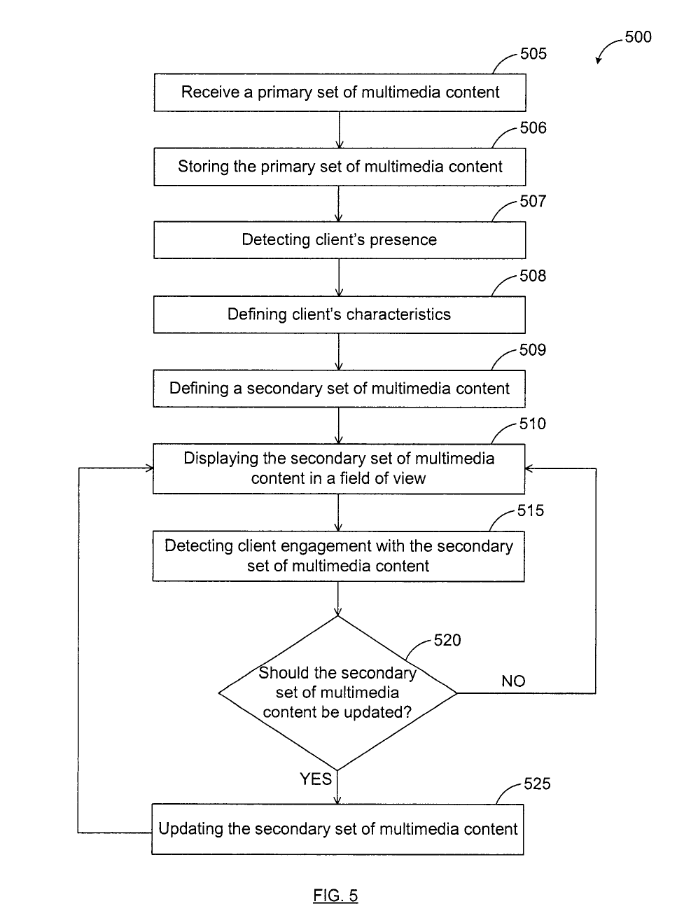

Referring now to FIG. 5, there is illustrated a process flow 500 that may be followed by a multimedia content delivery system in accordance with an example embodiment. It will be appreciated that many of the steps of the process flow 500 may be performed in a different order from the order in which they are shown in the figures and from the order in which they are described below. For example, some steps may be performed before the step they are shown to precede, and some steps may be performed concurrently. In addition, it will be appreciated that some of the steps of the process flow 500 may be omitted from the process as shown in the figures and from the process in which they are described below. For example, one embodiment of the multimedia content delivery system may not be configured for storing the primary set of multimedia content at 506, detecting client's presence at 507, and/or defining client's characteristics at 508. Process flow 500 may be used by systems 100, 200, 300 and 400, and in particular, the multimedia content delivery system 100 and 200, as described above with reference to the examples shown in FIGS. 1, 2, 3 and 4.

The various steps in the examples of the process flow 500 described below and shown in the Figures may be combined. For example, a new step described in relation to one example of the process flow 500 may be incorporated into a different example of the process flow 500 even if not explicitly stated.

Process flow 500 begins at 505 with receiving a primary set of multimedia content. The primary set of multimedia content may be received from a multimedia content server, such as, for example, the multimedia content server 110. Alternatively, the primary set of multimedia content may also be received from a multimedia content provider, such as, for example, the multimedia content provider 160. The primary set of multimedia content may also be received, for example, from both the multimedia content server 110 and multimedia content provider 160.

At 506, the primary set of multimedia content may be stored, as described herein.

At 507, the client's presence may be detected, as described herein.

At 508, the client's characteristics may be defined. In one embodiment, customization module 335 may be configured to define the client's characteristics based on determining client age or gender, as described herein.

At 509, a secondary set of multimedia content may be defined. In one embodiment, the secondary set of multimedia content is defined as the primary set of multimedia content, as described herein. In another embodiment, processor 305 may define the secondary set of multimedia content based on processing or modifying multimedia content, as described herein. In another embodiment, customization module 335 may define the secondary set of multimedia content based on determined client characteristics, as described herein. In a further embodiment, multimedia content server 110 may define the secondary set of multimedia content based on determining, processing or manipulating multimedia content, as described herein.

At 510, the secondary set of multimedia content may be displayed by a display apparatus, such as, for example, the display apparatus 120, as described herein. The secondary set of multimedia content may be the same as the primary set of multimedia content received by the display apparatus. The secondary set of multimedia content may be a processed variation of the primary set of multimedia content as described herein. For example, the secondary set of multimedia content may be a combination of some or all of the primary set of multimedia content with some or all of alternate multimedia content stored locally in the display apparatus, for example, in memory 310.

At 515, client engagement with the secondary set of multimedia content may be determined, as described herein.

At 520, whether or not the secondary set of multimedia content should be updated may be determined. As described herein, whether or not an update is required may be decided based on the client engagement as determined at 515. Alternatively, whether or not an update is required may be detected based on active client interaction with the display apparatus.

If it is determined that the secondary set of multimedia content should be updated, method 500 may proceed to 525. However, if it is determined that the secondary set of multimedia content should not be updated, method 500 may continue displaying the secondary set of multimedia content, as at 510.

At 525, the secondary set of multimedia content is updated. The secondary set of multimedia content may be updated by sending an updating request to the multimedia content server. In some examples, the updating request may comprise an indication of the client engagement with the secondary set of multimedia content. The multimedia content server may, based on the updating request, select and transmit a suitable primary set of multimedia content to the display apparatus. In some other examples, the updating request identifies the primary set of multimedia content that the multimedia content server should transmit.

In some embodiments, the second set of multimedia content comprises interactive content that allows the client to interact with the second set of multimedia content. The interactive content may comprise a barcode, such as, a Quick Response (QR) code. The interactive content may also comprise other optical machine-readable alpha-numeric characters. In one embodiment, the interactive content may allow the client to interact with the multimedia content directly or using a handheld device.

The interactive content may link the client directly to a multimedia content server, such as the multimedia content server 110, via a website. The website representing the multimedia content server may comprise links to one or more content related to the second set of multimedia content, such as, for example, advertisements, product details, discounts, games, contests etc. The website may also facilitate electronic purchasing of products or services through the website.

The interactive content may be read by any networked computing device comprising a processor and memory, such as a personal computer, a portable computer, a mobile device, a personal digital assistant, a laptop, a smart phone, a WAP phone, an electronic reading device, and portable electronic devices or a combination of these.

The networked computing device may comprise, residing or rendered in it, one or more of computing applications, application plug-ins, widgets, mobile device applications, e-mail applications, online telephony applications, java applications, web pages, or web objects for interacting with the interactive content.

The present invention has been described here by way of example only. Various modification and variations may be made to these exemplary embodiments without departing from the spirit and scope of the invention, which is limited only by the appended claims.

1. A method of providing multimedia content to a hair and beauty client, the method comprising:
receiving a primary set of multimedia content;
displaying a secondary set of multimedia content in a field of view, wherein the secondary set of multimedia content corresponds to the primary set of multimedia content;
detecting client engagement with the secondary set of multimedia content;
determining whether to update the secondary set of multimedia content in accordance with the client engagement; and
if update is required, updating the secondary set of multimedia content.

2. The method of claim 1, wherein the secondary set of multimedia content is the same as the primary set of multimedia content.

3. The method of claim 1, wherein the secondary set of multimedia content comprises the primary set of multimedia content and alternate content.

4. The method of claim 1, wherein the secondary set of multimedia content comprises a subset of the primary set of multimedia content.

5. The method of claim 4, wherein the secondary set of multimedia content further comprises alternate content.

6. The method of claim 1, wherein updating the secondary set of multimedia content comprises analyzing the client engagement to determine an engagement level, generating a request for updated multimedia content based on the engagement level and receiving the primary set of multimedia content based on the request for updated multimedia content.

7. The method of claim 1, further comprising detecting a presence of the client, wherein displaying the secondary set of multimedia content is based on the presence of the client.

8. The method of claim 1, further comprising determining a client characteristic and receiving the primary set of multimedia content based on the client characteristic.

9. The method of claim 1, further comprising updating the secondary set of multimedia content based on a client action.

10. The method of claim 1, wherein displaying the secondary set of multimedia content comprises displaying an interactive content to the client.

11. A system for providing multimedia content to a hair and beauty client, the system comprising:
a multimedia content server configured to store multimedia content; and
an apparatus operably connected to the multimedia content server over a network, the apparatus comprising:
a network interface configured to receive a primary set of multimedia content from the multimedia content server;
a display module configured to display a secondary set of multimedia content in a field of view, the secondary set of multimedia content corresponding to the primary set of multimedia content;
an engagement detection module configured to detect client engagement with the secondary set of multimedia content;
a processor configured to determine whether to update the secondary set of multimedia content; and
an updating module configured to update the secondary set of multimedia content.

12. The system of claim 11, wherein the secondary set of multimedia content is the same as the primary set of multimedia content.

13. The system of claim 11, wherein the secondary set of multimedia content comprises the primary set of multimedia content and alternate content.

14. The system of claim 11, wherein the secondary set of multimedia content comprises a subset of the primary set of multimedia content.

15. The system of claim 11, wherein the secondary set of multimedia content further comprises alternate content.

16. The system of claim 11, wherein the system is further configured to analyze the client engagement to determine an engagement level and to generate a request for updated multimedia content based on the engagement level and wherein the system is further configured to receive the primary set of multimedia content based on the request.

17. The system of claim 11, further comprising a presence detection module configured to detect a presence of the client, wherein the system is configured to display the secondary set of multimedia content based on the presence of the client.

18. The system of claim 11, further comprising a customization module configured to determine client characteristics, wherein the system is configured to receive the primary set of multimedia content based on the client characteristic.

19. The system of claim 11, wherein the system is configured to update the secondary set of multimedia content based on a client action.

20. The system of claim 11, wherein the apparatus is detachably attached to a mounting surface.

21. The system of claim 11, wherein the system comprises at least one of a sensor and a camera.

22. An apparatus for providing multimedia content to a hair and beauty client, the apparatus comprising:
a network interface configured to receive a primary set of multimedia content from a multimedia content server;
a display module configured to display a secondary set of multimedia content in a field of view, the secondary set of multimedia content corresponding to the primary set of multimedia content;
an engagement detection module configured to detect client engagement with the secondary set of multimedia content;
a processor configured to determine whether to update the secondary set of multimedia content; and
an updating module configured to update the secondary set of multimedia content.

23. The apparatus of claim 22, further comprising a memory configured to store the primary set of multimedia content.

24. The apparatus of claim 22, wherein the secondary set of multimedia content is the same as the primary set of multimedia content.

25. The apparatus of claim 22, wherein the secondary set of multimedia content comprises the primary set of multimedia content and alternative multimedia content.

26. The apparatus of claim 22, wherein the secondary set of multimedia content comprises a subset of the primary set of multimedia content.

27. The apparatus of claim 22, further comprising a presence detection module configured to detect a presence of the client, wherein the apparatus is configured to display the secondary set of multimedia content based on the presence of the client.

28. The apparatus of claim 27, wherein the apparatus comprises at least one of a sensor and a camera.

29. The apparatus of claim 22, further comprising a customization module configured to determine client characteristics, wherein the apparatus is configured to receive the primary set of multimedia content based on the client characteristic.

30. The apparatus of claim 22, wherein the apparatus is configured to update the secondary set of multimedia content based on a client action.
